(19) United States
(12) Patent Application Publication
(10) Pub. No.: US 2003/0108749 A1
(43) Pub. Date: Jun. 12, 2003

(54) Plastic substrates with polysiloxane coating for TFT fabrication

(76) Inventor: Sunder Ram, San Jose, CA (US)

Correspondence Address: Kenneth M. Kaslow,, Director of Intellectual Property, FlexICs, Inc., 165 Topaz St., Milpitas, CA, 95035, US

(21) Appl. No.: 10/006,572

(22) Filed: Dec. 6, 2001

(51) Int. Cl. B32B 9/04

(52) U.S. Cl. 428/447

(57) ABSTRACT

A structure and method for protecting a plastic substrate from heat damage during fabrication of thin film transistors on the substrate is disclosed. A polymer coating is applied to the plastic substrate that can act as a thermal barrier and withstand the silicon crystallization temperature provided by laser annealing of amorphous silicon. A combination of both inorganic and organic polymer material, and specifically a polysiloxane coating, is found to prevent damage to the plastic substrate during the crystallization process.

A thin layer of polysiloxane liquid resin, when combined with a proper mixture of solvents, can be applied on the substrate by spin, dip or other similar techniques in less than 30 seconds. In order to enhance the cross linking density of the polymer network, the coating is subjected to a short pre-cure at one temperature followed by a longer postcure at a higher temperature for several hours. This curing can be carried out in a batch process, and thus does not affect the throughput. A thin layer of oxide can be deposited over the polymer coating prior to the deposition of an a-Si film if desired, or, alternatively, the a-Si film may also be applied directly over the polymer coating.

### BACKGROUND OF THE INVENTION

1. Field of the Invention

The present invention relates to the fabrication of thin-film transistors on inexpensive, low-temperature plastic substrates. More specifically, the invention relates to a novel way of coating the plastic substrates to protect them from the rigors of the fabrication process.

2. Related Art

A recent development in the manufacture of display panels for such applications as computers, cellular telephones, and personal data assistants (“PDAs”), is an interest in manufacturing the backplanes for such displays on plastic substrates rather than on standard glass, quartz or silicon wafer-based substrates. It is believed that the use of plastic substrates will result in displays that are 1) lighter in weight than present displays, 2) flexible, which will help to prevent damage from some mishandling such as impact or dropping of the device containing the display, and 3) lower in cost.

The physico-mechanical properties of the plastic substrate are very important for making flexible panel displays. In addition to requiring excellent dimensional stability of the film, characteristics such as surface and thickness uniformity, light transmission, surface scratch resistance, adhesion, chemical resistance and, permeability of moisture and gas play key roles in the development of liquid crystal display (“LCD”) and organic light emitting diode (“OLED”) displays.

The types of plastic for which these properties are suitable for use in displays are incapable of withstanding the processing temperatures used in conventional thin film transistor fabrication techniques, which typically may reach 600° C. or more. Thus, various techniques have been developed for reducing the temperatures required.

One such technique is to use a short laser pulse to crystallize silicon. The pulse generates a sufficiently high temperature to crystallize the silicon locally, without subjecting the entire substrate to the same high temperature. Thus, in a thin-film transistor (“TFT”) fabrication process such as that shown in Carey et al, U.S. Pat. No. 5,817,550, a plastic substrate is coated with an oxide such as silicon dioxide (SiO₂). An amorphous silicon (“a-Si”) film is deposited on the oxide-coated plastic substrate, and is then subjected to a pulse from a short-pulse ultra-violet laser, such as an XeCl excimer laser having a wavelength of 308 nm, for a time of less than 100 ns, to form a polycrystalline silicon (“poly-Si”) film.

Plastic substrates may tolerate localized temperatures above their melting point for extremely short periods, since the substrate itself may act as a heat sink and carry heat away from the point of high temperature. However, a high enough temperature will exceed this capacity and cause damage to the substrate. Tests suggest that even the localized high temperature generated during the short pulsed-laser crystallization process may cause local damage to the plastic substrate if the thickness of the SiO₂ coating layer is less than 2 μm. (A layer of a different oxide may need a different thickness.) Since the process time to deposit an oxide layer with a thickness of 2 μm is around 20 minutes, it is obvious that requiring a layer of this thickness will significantly reduce manufacturing throughput. Another problem is that the oxide is somewhat brittle, and a layer this thick may crack and render the device unusable.

### SUMMARY OF THE INVENTION

In order to reduce the time needed to deposit the SiO₂ layer and thus shorten the process while still protecting the plastic substrate, the present invention utilizes a polymer coating applied on the plastic substrate that can act as a thermal barrier and withstand the silicon crystallization temperature provided by the laser. It is advantageous if the polymer coating also has low moisture permeability and can thus act as a moisture barrier as well, although this is not a necessary part of the present invention.

A polymer coating which is a combination of both inorganic and organic polymet material, and specifically a polysiloxane coating, is found to prevent damage to the plastic substrate during the crystallization process.

A thin layer of polysiloxane liquid resin, when combined with a proper mixture of solvents, can be applied on the substrate by spin, dip or other similar techniques in less than 30 seconds. In order to enhance the cross linking density of the polymer network, the coating is subjected to a short pre-cure at one temperature followed by a longer postcure at a higher temperature for several hours. This curing can be carried out in a batch process, and thus does not affect the throughput. A thin layer of oxide can be deposited over the polymer coating prior to the deposition of an a-Si film if desired, or, alternatively, the a-Si film may also be applied directly over the polymer coating.

Other objects and advantages of the present invention will become apparent from the following description and accompanying drawings.

### DESCRIPTION OF THE DRAWINGS

The accompanying drawings, which are incorporated into and form a part of the disclosure, illustrate an embodiment of the invention and its method of use, and, together with the description, serve to explain the principles of the invention.

FIG. 1 is a cross-sectional view of a plastic substrate after bottom oxide and amorphous silicon depositions, and illustrating pulsed laser irradiation, according to the prior art.

FIG. 2 is a cross-sectional view of a plastic substrate after polymer coating, bottom oxide and amorphous silicon deposition, according to one embodiment of the present invention.

FIG. 3 is a cross-sectional view of a plastic substrate after polymer coating and amorphous silicon deposition, according to another embodiment of the present invention.

### DETAILED DESCRIPTION OF THE PREFERRED EMBODIMENT

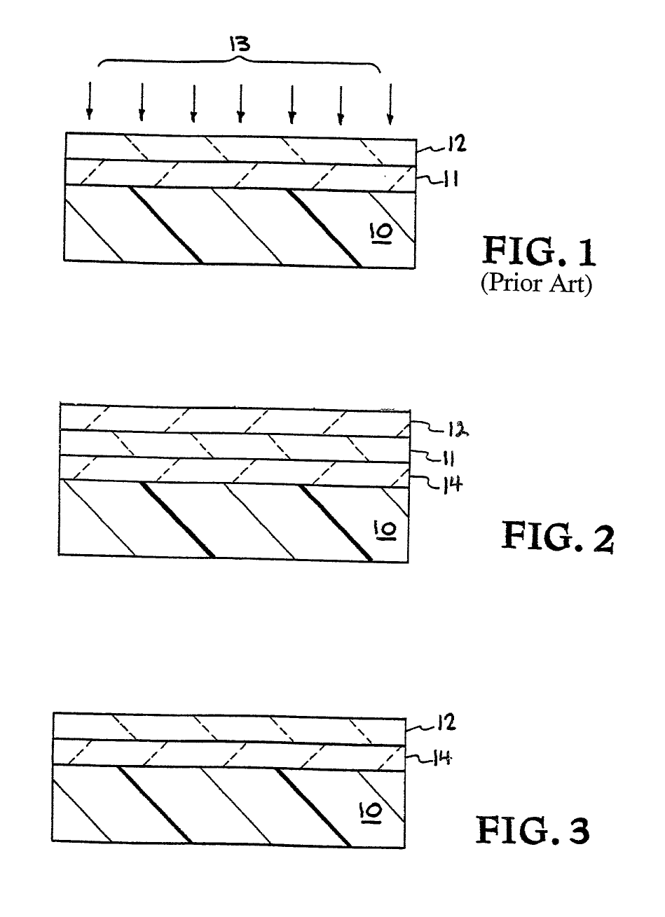

FIG. 1 illustrates the prior art as shown in Carey et al, U.S. Pat. No. 5,817,550. A plastic substrate 10, after cleaning and annealing if necessary, is coated with a first layer 11 of a thermally insulating dialectric material like SiO₂. The layer 11 may be applied by sputtering, physical vapor deposition (PVD), plasma enhanced chemical vapor deposition (PECVD), or any other manner not requiring high temperatures.

The plastic may be one of a variety of types having characteristics that make it acceptable for use as a substrate in a display device. Most tests to date have utilized polyethylene terephthalate (PET) as the substrate material, which cannot withstand temperatures greater than about 120° C. However, other materials having suitable characteristics are believed to include polyethylene naphthalate (PEN), polycarbonate (PC), polyarylate (PAR), polyetherimide (PEI), polyethersulphone (PES), polyimide (PI), Teflon polyperfluoro-alboxy fluoropolymer (PFA), polyether ether ketone) (PEEK), polyether ketone (PEK), polyethylene tetrafluoroethylenefluoropolymer (PETFE), and polymethyl methacrylate and various acrylate/methacrylate copolymers (PMMA). Certain of these plastic substrates can withstand higher processing temperatures of up to at least about 200° C., and some to 300-350° C. without damage.

After deposition of the insulating layer 11, an amorphous silicon film 12 having a thickness of 10 to 500 nm (most commonly in the range of 50 to 100 nm) is deposited on the insulating layer 11 by PECVD at a temperature of approximately 100° C. The a-Si film 12 is then crystallized to form a poly-Si film by irradiating it with one or more laser pulses, as indicated at 13 in FIG. 1. Again, an excimer laser is typically used, such as an XeCl excimer laser having a 308 nm wavelength.

As above, in the case of PET, tests suggest that the thickness of the insulating layer 11, if made of SiO₂, must be at least approximately 2 μm in order to prevent damage to the plastic during the laser annealing process. The use of other plastics as substrate material, or other dialectric materials as insulating layers, may require a different thickness.

It is known that certain inorganic polymers have characteristics of resistance to temperature, ultraviolet light and hydrolysis. Thus, the application of an inorganic polymer as a film between the plastic substrate and the oxide layer or silicon layer has the potential to protect the plastic substrate from thermal damage during the laser irradiation 13. However, inorganic polymers generally require high temperatures to achieve cross-linking, which is not a practical proposition for temperature-sensitive plastic substrates. Also, inorganic polymers tend to be brittle, and get more brittle as the thickness increases, and in this respect may not offer an advantage over an oxide layer.

Certain organic polymers like polyurethane or epoxies may also provide heat resistance and are quite flexible. However, organic polymers may absorb water and thus are not acceptable for display applications.

What is needed is a polymer that combines the benefits of both organic and inorganic polymers while minimizing the defects of each. One area of chemistry that has been regarded as an alternative for ambient film forming and cross-linking has been a hybrid of inorganic/organic materials, generally known as polysiloxanes. Polysiloxanes have been used as abrasion resistant coatings on such items as contact lenses and airplane windows, made from polycarbonates and acrylates, but do not appear to have been used as thermal or moisture barriers, or on plastics such as polyesters like PET and PEN.

The typical polysiloxane reactions involving hydrolytic silanol condensation are,

Si—OR+H₂O [symbol] Si—OH+ROH

Si—OH+HO—Si→Si—O—Si+H₂O

Si—OH+RO—Si→Si—O—Si+ROH

where R may be one of hundreds of organic groups. In general, aromatics, which contain benzene, have a tendency to turn yellow and thus do not meet the requirement of good light transmission. Aliphatics, which contain carbon chains, on the other hand, usually stay clear.

By combining organic and inorganic polymers, an acceptable compromise may be found in which the film properties, such as adhesion, flexibility, chemical resistance and durability, are all within acceptable limits. An ideal combination of organic and inorganic moieties is clearly not always easy to attain. A polymer with too low a level of organic component tends to produce films with too high a polysiloxane characteristic, i.e. glass-like films, but with poor qualities in other areas. Systems with too high a level of organic component, on the other hand, may detract from the polysiloxane properties, as well as being more difficult to prepare in a stable dispersion.

Polysiloxane based coatings give quite different properties than conventional epoxies and polyurethanes. A well-formulated polysiloxane system can impart excellent adhesion, flexibility, scratch resistance and chemical resistance. The glass transition (T_{g}) temperature of polysiloxanes after ageing is typically over 100° C., while epoxies and polyurethanes with similar solids content have glass transition temperatures on the order of 60° C. and thus will not protect the substrate. (The T_{g} of PEN is about 120° C.)

Another potential benefit is that a layer of polysiloxane or other similar material having a thickness of at least several microns may create a composite that has greatly improved thermo-mechanical properties (i.e. has a lower coefficient of thermal expansion, resulting in less dimensional change between process steps) than the plastic substrate alone. Moreover, the film can potentially act as planarization layer, creating a surface that is smoother than the substrate surface.

The internal stress of the polysiloxane film is also very low when compared to high solids epoxies, for example. The polysiloxanes exhibit a higher level of hydrophobic characteristics in relation to conventional coating materials. The combination of high hydrophobicity coupled with a high Tg allows polysiloxanes to be considered as a potential for moisture barrier applications, as well as a thermal barrier.

FIG. 2 illustrates one embodiment of the present invention. As in FIG. 1, there is a plastic substrate 10. Now, however, before the insulating layer 11 is added, a thin layer 14 of polymer material, such as polysiloxane, is deposited on the substrate by any method suitable to its particular composition. For example, the polymer may be applied by dipping the substrate in it, or spinning it on in the same fashion as many photoresist materials. The insulating layer 11 and silicon layer 12 are then added as before, although the insulating layer 11 may be significantly thinner than in FIG. 1. (The layer is added for reasons discussed below, since it is no longer the means for insulating the plastic substrate 10 from heat.)

FIG. 3 illustrates an alternative embodiment of the present invention. As in FIG. 2, plastic substrate 10 is first covered with a layer 14 of polymer material. However, now no insulating layer is present and silicon layer 12 is deposited directly on polymer layer 14.

One polysiloxane coating resin that was evaluated for this application is CrystalCoat™ MP-101, which is manufactured by SDC Coatings Inc., Anaheim, Calif. A similar material, TS-56HF, made by Tokuyama Corporation of Japan is also being investigated. Spinning the MP-101 on to a plastic substrate for 20 seconds produced a layer in the range of 1.5 to 2 μm. The MP-101 was then pre-cured at 92° C. for 15 minutes, followed by a postcure at 115° C. for 3 hours.

The PEN substrate coated with MP-101 showed no visual damage when subjected to chemical compatibility tests using acetone, methanol and various acids including hydrofluoric acid. The evaluation of the moisture barrier properties of polysiloxanes in general, and MP-101 in particular, is being pursued, but initial tests show no significant moisture absorption.

It is believed that a thicker polymer layer will be more heat and moisture resistant, and that if the polymer layer is thick enough and smooth enough, and defect free, then no oxide is necessary and the amorphous silicon may be deposited directly on the polymer layer as shown in FIG. 3. However, attempts to increase the thickness of a layer of MP-101 to more than 3 μm are believed to result in the surface becoming less uniform than a thinner layer due to the presence of streaks and lines, and unacceptable for further processing. One approach that appears to avoid this problem is to spin on a coat of the material, cure it, and then add another coat to achieve the desired thickness.

Another concern is that there may be small defects in the polymer layer. An approach being investigated is to spin on a coat of polymer such as MP-101, cure it, and then add a thin layer of oxide, for example a layer of SiO₂ that is 0.5 μm thick or less, to cover these defects and smooth the surface if necessary. This will still result in a reduction in the processing time needed to grow the oxide layer of approximately 80% or more.

It is known in the industry that the handling of a bare flexible plastic sheet is an area of concern, due to scratches that may be left in the surface at various process steps. Application of the polysiloxane coating on both sides of the plastic wafer at the initial stage of the process would also serve to create an abrasion resistant layer for the ensuing steps.

Many alternative embodiments are possible but have not yet been tested. For example, dual or multiple layers of polysiloxane and an inorganic coating might also be considered, and their heat and moisture permeation barrier characteristics tested. Another layer of polysiloxane might be added on top of the oxide, or even multiple alternating layers of polymer and oxide might be used.

As an alternative to thermal cure systems, development of polysiloxane barrier films using radiation cure chemistry including ultra violet (UV) and electron beam (EB) technology will also be reviewed and conducted. This should provide an instant film without the requirement of a long post-curing step.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

What is claimed is:

1. A composite material for use in fabricating semiconductor devices, comprising:
a plastic substrate;
a substantially transparent dialectric layer; and
a polymer layer between the plastic substrate and the dialectric layer that protects the plastic substrate from heat damage during processing of the semiconductor devices.

2. The composite material of claim 1, wherein the plastic substrate is a material selected from the group consisting of PET, PEN, PC, PAR, PEL, PES, PI, Teflon PFA, PEEK, PEK, PETFE and PMMA.

3. The material of claim 1, wherein the polymer material in the thermal barrier is a combination of one or more organic polymers and one or more inorganic polymers.

4. The material of claim 1, wherein the polymer material in the thermal barrier is a polysiloxane.

5. The material of claim 1, wherein the dialectric layer is comprised of SiO₂, SiN, Al₂O₃ or polyamide.

6. The material of claim 1, further comprising a layer of silicon.

7. The material of claim 6, wherein the silicon is amorphous silicon.

8. The material of claim 6, wherein the silicon is polycrystalline silicon.

9. The material of claim 6, wherein the silicon is crystalline silicon.

10. A method of producing a composite material for use in fabricating semiconductor devices, comprising:
providing a plastic substrate;
applying a layer of polymer material over the plastic substrate that protects the plastic substrate from heat damage during processing of the semiconductor devices; and
applying a substantially transparent dialectric layer over the thermal barrier.

11. The method of claim 10, wherein step of providing a plastic substrate further comprises providing substrate composed of a material selected from the group consisting of PET, PEN, PC, PAR, PEL, PES, PI, Teflon PFA, PEEK, PEK, PETFE and PMMA.

12. The method of claim 10, wherein step of applying a layer of polymer material further comprises applying a material which is a combination of one or more organic polymers and one or more inorganic polymers.

13. The method of claim 10, wherein the step of applying a layer of polymer material further comprises applying a material which is a polysiloxane.

14. The method of claim 10, wherein the step of applying a transparent dialectric layer further comprises applying a layer of SiO₂, SiN, Al₂O₃ or polyamide.

15. The method of claim 1, further comprising the step of applying a layer of silicon over the dialectric layer.

16. The method of claim 15, wherein the step of applying a silicon layer further comprises applying a layer of amorphous silicon.

17. The method of claim 15, wherein the step of applying a silicon layer further comprises applying a layer of polycrystalline silicon.

18. The method of claim 15, wherein step of applying a silicon layer further comprises applying a layer of crystalline silicon.
